(19) United States
(12) Patent Application Publication
(10) Pub. No.: US 2023/0128524 A1
(43) Pub. Date: Apr. 27, 2023

(54) CALL BLOCKING AND/OR PRIORITIZATION IN HOLOGRAPHIC COMMUNICATIONS

(71) Applicant: AT&T Intellectual Property I, L.P., Atlanta, GA (US)

(72) Inventor: Joseph Soryal, Glendale, NY (US)

(73) Assignee: AT&T Intellectual Property I, L.P., Atlanta, GA (US)

(21) Appl. No.: 17/509,592

(22) Filed: Oct. 25, 2021

(51) Int. Cl. G06T 19/00; H04L 12/58; H04L 29/08

(52) U.S. Cl. CPC G06T 19/006; H04L 51/32; H04L 67/1044

(57) ABSTRACT

Aspects of the subject disclosure may include, for example, receiving first imaging data corresponding to first images of a first plurality of first users, each of the first users being located at a first location; obtaining first hierarchical rank data, the first hierarchical rank data being indicative of a first hierarchical ranking of each of the first users relative to each other of the first users; generating, based at least in part upon the first imaging data and the first hierarchical rank data, second imaging data, and sending the second imaging data to a second location, the second location being separate from the first location, the second imaging data enabling a first holographic projector at the second location to present first holograms, the first holograms comprising one or more first emphasized images representing a first particular one of the first users who is ranked highest by the first hierarchical rank data, and the first holograms further comprising one or more first un-emphasized images representing one or more first other users of the first users who are not ranked highest by the first hierarchical rank data. Other embodiments are disclosed.

### FIELD OF THE DISCLOSURE

The subject disclosure relates to call blocking and/or prioritization in holographic communications.

### BACKGROUND

Holographic communications can be carried out between parties. For example, a first camera and a first holographic projector can be disposed at a first location. A second camera and a second holographic projector can be disposed at a second location. The first camera can obtain first images of one or more people at the first location and such first images (and/or data representing such first images) can be transmitted to the second projector at the second location. The second projector can then cause corresponding holographic images to be displayed at the second location. Similarly, the second camera can obtain second images of one or more other people at the second location and such second images (and/or data representing such second images) can be transmitted to the first projector at the first location. The first projector can then cause corresponding holographic images to be displayed at the first location.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (that can function fully or partially within the communication network of FIG. 1) in accordance with various aspects described herein.

FIG. 2B is a block diagram illustrating an example, non-limiting embodiment of a system (that can function fully or partially within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for call blocking and/or prioritization in holographic communications. Other embodiments are described in the subject disclosure.

Various embodiments can provide a system (sometimes referred to herein as Holographic Communication Call Management System (or HCCMS)) that resides at one or more of the following locations: (a) Receiver Projection System (in one example, this can be controlled by a receiver party (e.g., a person at one end of a holographic communication)); (b) Sender Camera System (in one example, this can be controlled by a sender party (e.g., a person at another end of the holographic communication)); (c) Network Based System (in one example, this can be controlled by a telecommunication carrier); (d) any combination thereof.

In various examples, the HCCMS can comprise: (a) one or more software applications; (b) one or more firmware applications; (c) one or more hardware components; (d) any combination thereof.

In various examples, the HCCMS can be configurable by a given user (e.g., a person receiving a holographic communication, a person sending a holographic communication, a system owner, or any combination thereof). In one example, the HCCMS can be configurable by a given user to allow incoming holographic communication(s) from certain other user(s). In various specific examples, the HCCMS can be configurable by a given user to allow incoming holographic communications from certain other user(s) during one or more certain times (e.g., during work hours) and/or under one or more certain conditions (e.g., emergency). In another example, the HCCMS can be configurable by a given user to block incoming holographic communication(s) from certain other user(s). In various specific examples, the HCCMS can be configurable by a given user to block incoming holographic communication(s) from certain other user(s) during one or more certain times (e.g., during non-work hours) and/or under one or more certain conditions (e.g., non-emergency).

In one example, a person sending a holographic communication can configure the HCCMS to only project one or more holograms of a subset of the people in a room (that is, project one or more holograms corresponding to some of the people in a room, while not projecting a hologram for at least one other person in the room). In one specific example, one or more holograms corresponding to key team personnel in a room can be projected while one or more holograms corresponding to anyone else who is present in the room will not be projected to the receiver party).

In various examples, the HCCMS can utilize one or more whitelists (or allow lists), one or more blacklists (or block lists), or any combination thereof.

In one example, a given user of the HCCMS can set one or more priorities specifying which hologram(s) should “shine” (and/or otherwise be emphasized) and/or which hologram(s) should be at the center of a meeting in the projection space (in one specific example, the HCCMS can control the hologram projection(s) to execute these preferences (e.g., these one or more priorities)).

In one example, the HCCMS can implement “intelligence” to learn the preference(s) of a given user. In one specific example, after learning preference(s), the HCCMS can (e.g., next time) take action(s) autonomously (for instance, if a given user gets annoyed at a certain product hologram projection, the next time that a telemarketer calls with this hologram projection, the HCCMS will alert the given user before projecting a hologram of the product (this can, for example, provide the given user a chance to cancel the projection before it happens).

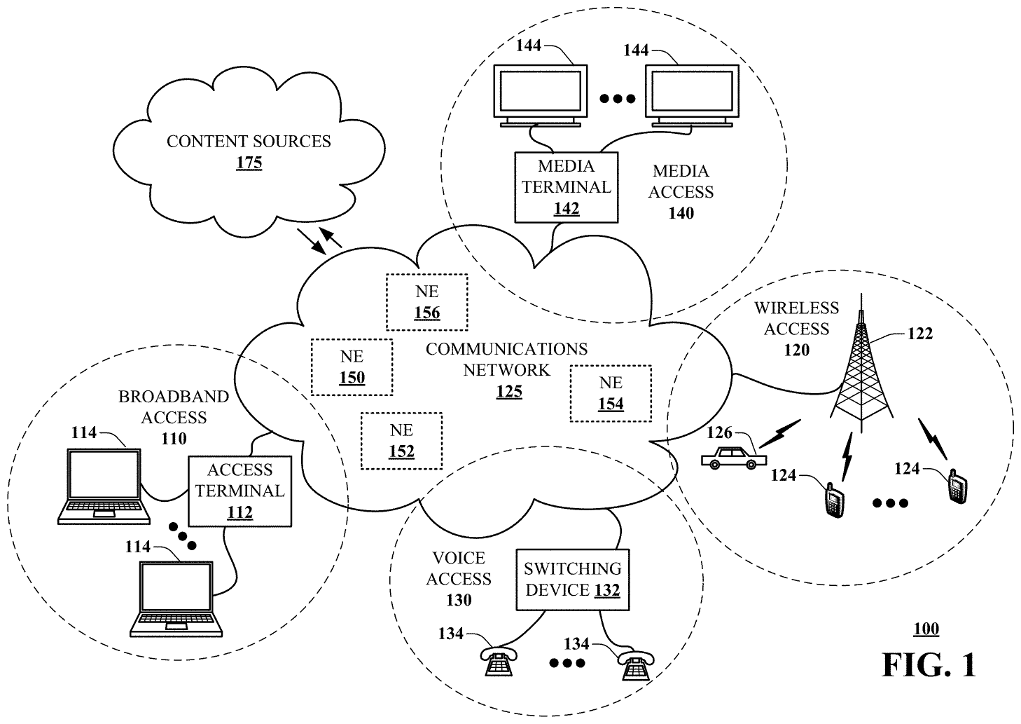

Referring now to FIG. 1, a block diagram is shown illustrating an example, non-limiting embodiment of a system 100 in accordance with various aspects described herein. For example, system 100 can facilitate in whole or in part call blocking and/or prioritization in holographic communications. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

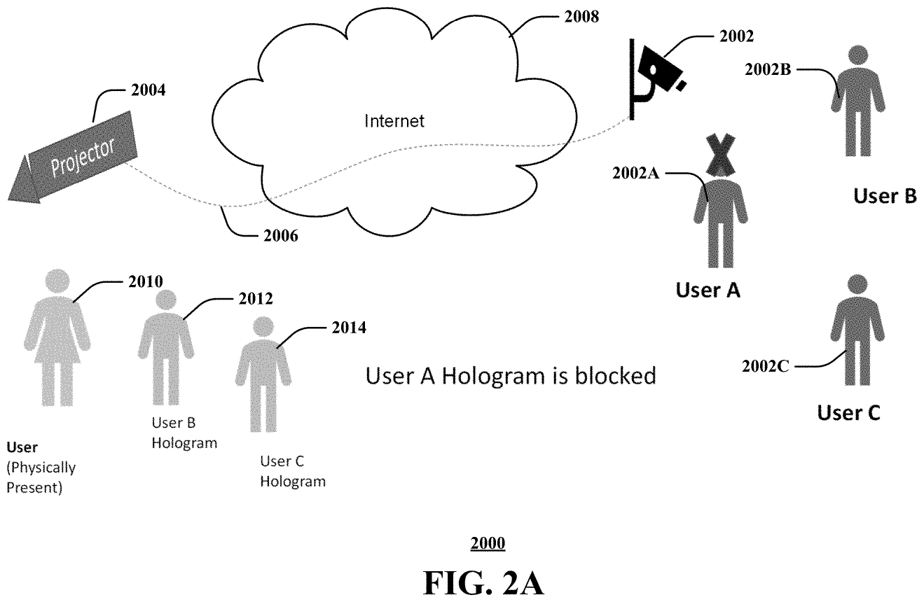

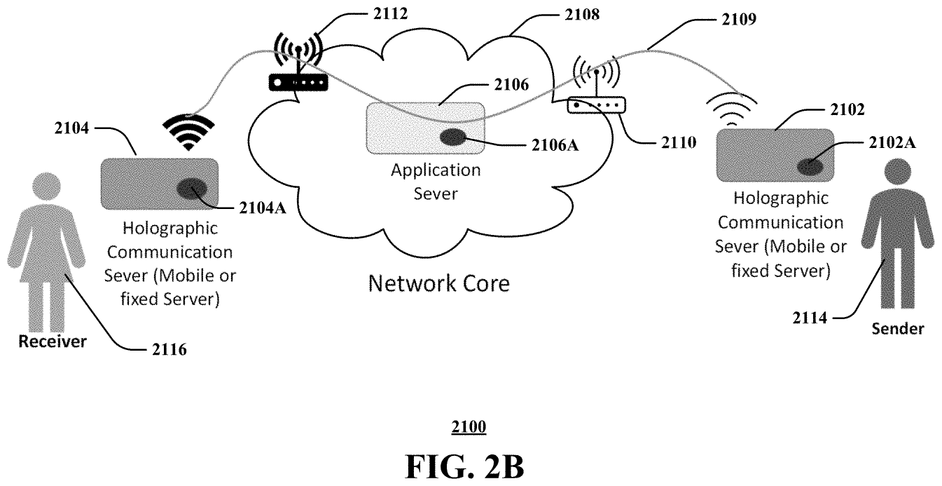

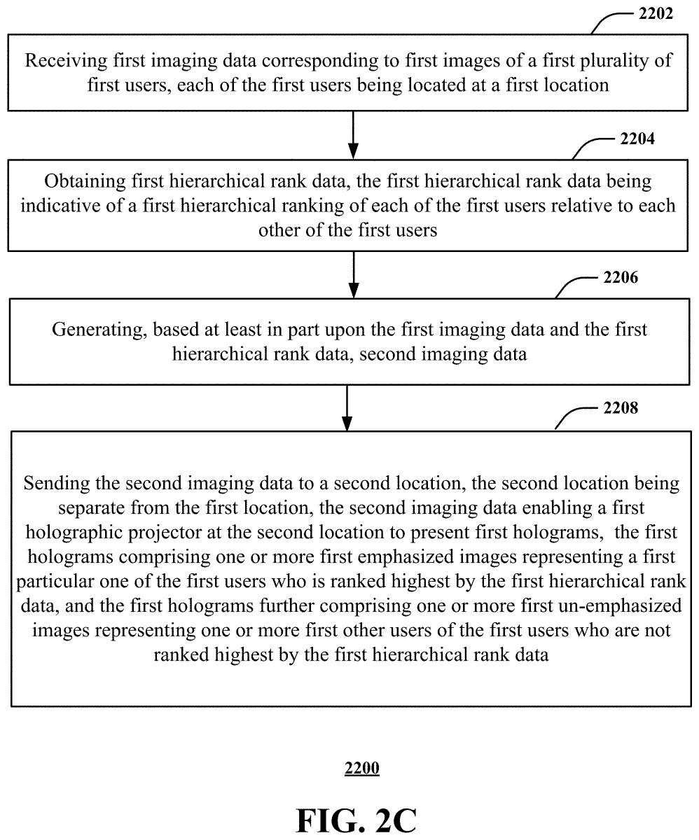

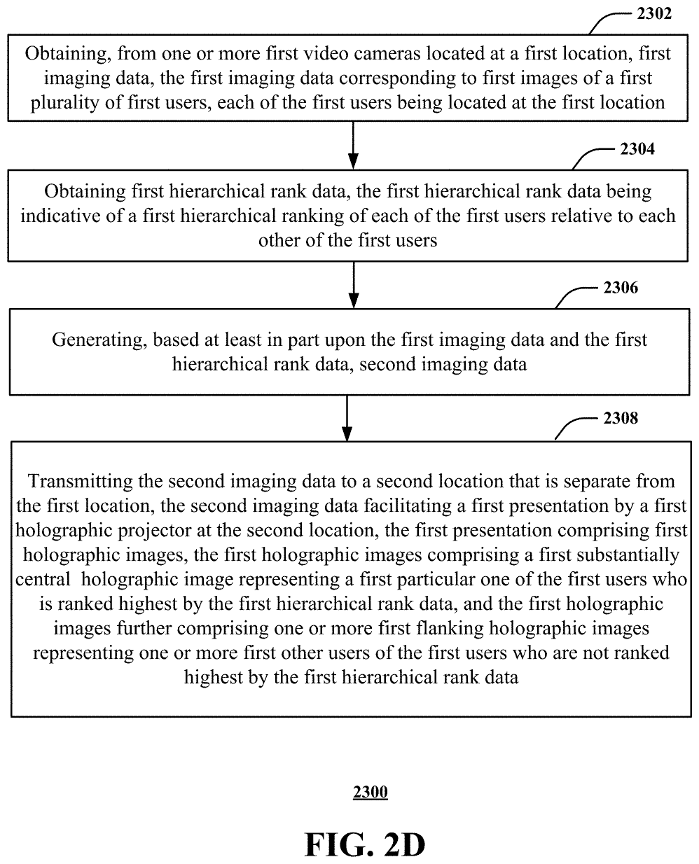

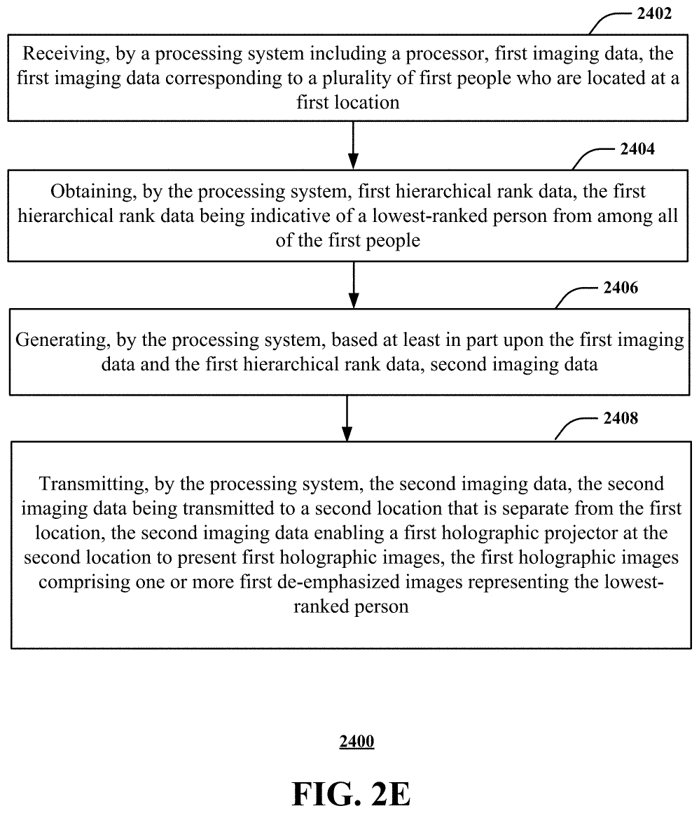

Referring now to FIG. 2A, this is a block diagram illustrating an example, non-limiting embodiment of a system 2000 in accordance with various aspects described herein. As seen in this figure, one or more cameras 2002 can be located at a first location (e.g., a conference room or the like). In this example, three users (User A 2002A, User B 2002B, and User C 2002C) are physically located at the first location and are within a field of view of the one or more cameras 2002. Further, one or more holographic projectors 2004 are located at a second location (e.g., a conference room or the like). The second location is remote from the first location and is in bidirectional communication 2006 via the Internet 2008 (either directly or indirectly) with the one or more cameras 2002. In this example, there is one User 2010 physically present at the second location. In addition, projector 2004 projects (for viewing by User 2010) a hologram 2012 of User B (who is physically located at the first location) and a hologram 2014 of User C (who is physically located at the first location). Of note, in this example, there is no hologram presented to User 2010 of User A (who is physically located at the first location). That is, a hologram presentation of User A to User 2010 has, in this example, been blocked. The blocking can occur as a result of one or more preferences, rankings, priorities, and/or the like as described herein.

Referring now to FIG. 2B, this is a block diagram illustrating an example, non-limiting embodiment of a system 2100 in accordance with various aspects described herein. As seen in this figure (which shows various system components & architecture), a holographic communication server 2102 (which can be, for example, mobile or fixed) includes holographic communication call management system (or HCCMS) 2102A. Further, a holographic communication server 2104 (which can be, for example, mobile or fixed) includes holographic communication call management system (or HCCMS) 2104A. Further still, application server 2106 (which can reside in network core 2108) includes holographic communication call management system (or HCCMS) 2106A. In operation, sender party 2114 can engage in holographic communications 2109 (via wireless access points 2110 and 2112) with receiver party 2116. Of course, the holographic communications can be bi-directional, such that receiver party 2116 sends and receives images (and/or other information) with respect to sender party 2114 and sender party 2114 sends and receives images (and/or other information) with respect to receiver party 2116.

Still referring to FIG. 2B, in various examples, each holographic communication server (see, e.g., 2102, 2104) can: (a) comprise hardware and/or a virtual machine; and/or (b) be a server (e.g., a fixed or mobile server) that resides at the respective communicating party and controls the hardware elements such as one or more cameras and one or more projectors (in one specific example, each of these servers 2102, 2104 controls the respective projector(s) and/or camera(s) to ensure the “priority” of appearances are enforced as to which hologram(s) should be at the center; in another specific example, each of these servers 2102, 2104 controls the respective projector(s) and/or camera(s) to eliminate person(s) and/or object(s) not desired to be part of the communication session).

Still referring to FIG. 2B, in various examples the application server (see, e.g., 2106) can: (a) comprise hardware and/or a virtual machine; (b) reside in the core network (see, e.g., 2108) of the service provider; (c) facilitate registration by users to use the service; (d) store and maintain users' profiles; and/or (e) block spammers mid-flight in the network using HCCMS rules for certain user(s)—since (in one example) this application server resides in the network, it knows spammers and can thus block them.

Still referring to FIG. 2B, in various examples the HCCMS (see, e.g., 2102A, 2104A, 2106A) can: (a) be an application that resides on each respective holographic communication server (see, e.g., 2102, 2104) locally; (b) be an application that resides in the network application server (see, e.g., 2106); and/or (c) store and maintain the users' call preferences and configurations.

Reference will now be made to system implementation and operation steps according to an embodiment. In this regard, the first step can be user registration for the service. More particularly, a user can purchase the service and be provided with a holographic communication server (see, e.g., elements 2102A, 2104A of FIG. 2B) that is installed locally (in various examples, each holographic communication server can be hardware and/or a virtual machine that resides on one or more of the user's other devices—for instance, laptop, phone, Internet-Of-Things (IoT) device, etc. . . . ). In various examples, each holographic communication server can control the respective projection and camera elements (e.g., hardware elements) for a holographic communication. In various examples, user profile and/or subscription information (e.g., for a plurality of users) can be stored in each holographic communication server and in the network application server, wherein the servers are in constant communication.

Still referring to certain system implementation and operation steps according to an embodiment, each user can (e.g., after respective registration) configure preferences. In this regard, each user can configure their preferences on the respective HCCMS that resides on the respective server. In various examples, each of the configurations can include: (a) preference for call blocking of unknown numbers and/or after hours; (b) preference to drop unimportant calls (e.g., drop a call if my boss calls); and/or (c) preference to block an infomercial call if I am at work. In various examples, each of these configurations also get stored in the HCCMS of the network application server so that the network is enabled to make global decisions such as block a call in the network before it reaches the user. In various examples, each local HCCMS can be for short term rules—the system can get further instruction from a respective user during the call to take one or more actions (e.g., a friend is talking to me but my boss calls, I can command the system to drop the first call (with friend) and pick the boss's call. In various examples, an HCCMS can be configured for short term preference, such as block all friend's calls today until I am done with work. In various examples, each holographic communication server controls the respective projector(s) to implement “priority” configuration as to which hologram(s) should be more visible than others.

Reference will now be made to the steps of making a holographic call according to an embodiment. More particularly, according to this embodiment, a holographic call is made as follows: (a) User A wants to call User B; (b) User A commands (e.g., verbally and/or via body gestures) the holographic communication server of User A (see, e.g., 2102, 2104 of FIG. 2B) to call User B; (c) The holographic communication server of User A connects to the application server (see, e.g., 2106 of FIG. 2B) and verifies that Users A and B are valid users; (d) The holographic communication server of User A operates the respective camera(s) and projector(s) for User A; (e) The application server communicates with the holographic communication server of User B, and this holographic communication server of User B operates the hardware resources (e.g., camera(s) and projector(s)) at User B space); (f) Each respective HCCMS gets activated for each respective user and implements each respective preconfigured set of rules; and/or (g) Each HCCMS has the ability to learn and create rules on the fly (in real-time) and implement such rules on the fly (in real-time)—in various examples, such rules can comprise terminating an inappropriate hologram projection.

Referring now to FIG. 2C, various steps of a method 2200 according to an embodiment are shown. As seen in this FIG. 2C, step 2202 comprises receiving first imaging data corresponding to first images of a first plurality of first users, each of the first users being located at a first location. Next, step 2204 comprises obtaining first hierarchical rank data, the first hierarchical rank data being indicative of a first hierarchical ranking of each of the first users relative to each other of the first users. Next, step 2206 comprises generating, based at least in part upon the first imaging data and the first hierarchical rank data, second imaging data. Next, step 2208 comprises sending the second imaging data to a second location, the second location being separate from the first location, the second imaging data enabling a first holographic projector at the second location to present first holograms, the first holograms comprising one or more first emphasized images representing a first particular one of the first users who is ranked highest by the first hierarchical rank data, and the first holograms further comprising one or more first un-emphasized images representing one or more first other users of the first users who are not ranked highest by the first hierarchical rank data.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2300 according to an embodiment are shown. As seen in this FIG. 2D, step 2302 comprises obtaining, from one or more first video cameras located at a first location, first imaging data, the first imaging data corresponding to first images of a first plurality of first users, each of the first users being located at the first location. Next, step 2304 comprises obtaining first hierarchical rank data, the first hierarchical rank data being indicative of a first hierarchical ranking of each of the first users relative to each other of the first users. Next, step 2306 comprises generating, based at least in part upon the first imaging data and the first hierarchical rank data, second imaging data. Next, step 2308 comprises transmitting the second imaging data to a second location that is separate from the first location, the second imaging data facilitating a first presentation by a first holographic projector at the second location, the first presentation comprising first holographic images, the first holographic images comprising a first substantially central holographic image representing a first particular one of the first users who is ranked highest by the first hierarchical rank data, and the first holographic images further comprising one or more first flanking holographic images representing one or more first other users of the first users who are not ranked highest by the first hierarchical rank data.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2400 according to an embodiment are shown. As seen in this FIG. 2E, step 2402 comprises receiving, by a processing system including a processor, first imaging data, the first imaging data corresponding to a plurality of first people who are located at a first location. Next, step 2404 comprises obtaining, by the processing system, first hierarchical rank data, the first hierarchical rank data being indicative of a lowest-ranked person from among all of the first people. Next, step 2406 comprises generating, by the processing system, based at least in part upon the first imaging data and the first hierarchical rank data, second imaging data. Next, step 2408 comprises transmitting, by the processing system, the second imaging data, the second imaging data being transmitted to a second location that is separate from the first location, the second imaging data enabling a first holographic projector at the second location to present first holographic images, the first holographic images comprising one or more first de-emphasized images representing the lowest-ranked person.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various examples, a plurality of holograms can be emphasized based upon hierarchical rank data. In one specific example, a hologram representing a highest ranked person can be presented with the most emphasis, a hologram representing a second-highest ranked person can be presented with the second-most emphasis, a hologram representing a third-highest ranked person can be presented with the third-most emphasis, etc.

In various examples, a plurality of holograms can be de-emphasized based upon hierarchical rank data. In one specific example, a hologram representing a lowest ranked person can be presented with the most de-emphasis, a hologram representing a second-lowest ranked person can be presented with the second-most de-emphasis, a hologram representing a third-lowest ranked person can be presented with the third-most de-emphasis, etc.

In various examples, a plurality of holograms can be positioned based upon hierarchical rank data. In one specific example, a hologram representing a highest ranked person can be presented in a most centered location (and/or a most forward location), a hologram representing a second-highest ranked person can be presented in a second-most centered location (and/or a second-most forward location), a hologram representing a third-highest ranked person can be presented in a third-most centered location (and/or a third-most forward location), etc. In other specific examples, a hologram representing a lowest ranked person can be presented in a least centered location (and/or a least forward location), a hologram representing a second-lowest ranked person can be presented in a second-least centered location (and/or a second-least forward location), a hologram representing a third-lowest ranked person can be presented in a third-least centered location (and/or a third-least forward location), etc. In another example, the positioning of the holograms that are presented can be independent of the physical positioning of the people at the sending location.

As described herein, in various embodiments each HCCMS can provide a robust mechanism to identify each hologram and to tie the hologram to the original person (e.g., to prevent imposters and/or spoofing).

As described herein, in various embodiments a given user can instruct the HCCMS (e.g., by verbal command). For instance, a given user can verbally state that “I do not want to see Smith's hologram”, so even if Smith tries to hide himself and pop up in one of this user's meetings, the system will identify Smith and block him. In one specific example, to address a case that Smith tries to alter his appearance, the system can perform the following: (a) the HCCMS takes a secret feature from a person (or object) and passes this piece of image through a unique hash function only known to the local system and ties this hash function to the person (certain conventional identification mechanisms operate, for example, with respect to facial recognition, but the HCCMS may choose instead the hands, neck, etc. . . . ) and marks the person via this secret body part; (b) in case of spoofing, if I am expecting a call from John and someone spoofs John's number to project someone else's hologram, the system will check its database on the secret identifier(s) for John before passing the call/hologram to me; (c) the HCCMS can ask the caller to move into certain angles so it can capture the secret body part for the hash function; (d) the image gets converted to bits and the bits go through the secret hash function; and/or (e) the HCCMS becomes the call manager for the user to configure the holographic interactions and catch fraudsters.

As described herein, in various embodiments a mechanism can be provided to enable a person (e.g., a receiver party and/or a sender party) to assign an allow list and/or a block list of certain people (with respect to permitting or not permitting such certain people to have their holograms appear in the receiver's space). For instance, the sender party's system (e.g., camera) can see four people and can send data for four holograms to the receiver party; the sender party and/or receiver party can exclude one or more persons from having their holograms be transmitted or displayed (e.g., this excluded person could be a non-participant of a meeting and was just present by accident).

As described herein, in various embodiments a mechanism can be provided to enable a person (e.g., a receiver party and/or a sender party) to set a priority to have some displayed hologram(s) more apparent than other(s) during a single call where multiple calling parties and their holograms are present at the receivers' space. For instance, if the receiver has three holograms displayed in their office, the receiver can control which hologram should be more apparent (e.g., more visible and the other(s) less visible). This functionality can be particularly useful in a case that a location is crowded and/or too small to project all three holograms in clear high-resolution manner.

As described herein, various embodiments can provide a mechanism for reducing or eliminating hologram projections of unwanted appearances (e.g., unwanted appearances similar to certain conventional spam, spoofed calls, and unwanted robocalls, wherein unwanted people and/or objects may otherwise have their holograms pop up at the receiver which may cause annoyance and inconvenience).

As described herein, various embodiments can provide a mechanism for reducing or eliminating unwanted hologram projections that could be projected by one communicating party or by a third party that injects their hologram in the line. For instance, two parties are communicating via holographic communication and one party decides to force another hologram (another person or object) to the receiver—under various embodiments the receiver party can set beforehand what they would allow in terms of received holograms (so an illegal or undesired robocaller/telemarketer cannot bombard such receiver party with unwanted holograms for merchandise or the like).

As described herein, various embodiments can provide a mechanism for reducing or eliminating unwanted hologram projections such as, for example, when someone spoofs my friend's phone number and I pick up expecting my friend's hologram would appear but someone else's hologram comes out.

As described herein, various embodiments can provide a mechanism for holographic communications between remote locations. In one specific example, holographic communications can be carried out between two locations—for instance, a conference room (including (camera(s) and projector(s)) in New York and a conference room (including (camera(s) and projector(s)) in London. In another specific example, holographic communications can be carried out among three or more locations—for instance, a conference room (including (camera(s) and projector(s)) in New York, a conference room (including (camera(s) and projector(s)) in London, and a conference room (including (camera(s) and projector(s)) in Paris.

As described herein, various embodiments can provide a mechanism for holographic communications utilizing one or more block lists and/or one or more allow lists. In one specific example, holographic communications can be carried out between a first location and a second location, at which a trade show is occurring (in this example, salespeople at the tradeshow can be on an allow list (with respect to holographic presentation at the first location) and other people at the tradeshow can be on a block list (with respect to holographic presentation at the first location).

As described herein, various embodiments can provide a mechanism to present one or more holograms with respective priority (e.g., higher priority equals brighter and/or centered and lower priority equals dimmer and/or non-centered). In one specific example, a junior engineer at a company can have a lower rank (or priority) and a vice-president at the company can have a higher rank (or priority).

As described herein, various embodiments can provide a mechanism to assign ranks (or priorities). In various examples, the ranks (or priorities) can be assigned from the sending side, from the receiving side, or from any combination thereof.

As described herein, various embodiments can provide a mechanism for visual projection management.

As described herein, various embodiments can provide a mechanism to reject one or more incoming holograms (e.g., an explicit spoofed hologram, a hologram with unwanted advertising).

As described herein, various embodiments can provide a mechanism that is implemented by a carrier/service provider (and/or locally at the receiver side, the sender side, or any combination thereof).

As described herein, various embodiments can provide a mechanism to set preferences. (e.g., user preferences). In one specific example, preferences (and/or ranks and/or priorities) can be set via a graphical user interface (GUI). In another specific example, preferences (and/or ranks and/or priorities) can be set in advance of a given holographic communication. In another example, preferences (and/or ranks and/or priorities) can be changed during a given holographic communication. In another specific example, a holographic communication can be automatically blocked (e.g., an incoming holographic communication can be automatically blocked). In another specific example, an existing holographic communication can be automatically terminated (e.g., an existing holographic communication can be automatically ended). In another specific example, privacy and/or blocking can be scheduled for one or more desired times (e.g., one or more predetermined times). In another specific example, privacy and/or blocking can be changed during an emergency.

As described herein, various embodiments can utilize rules (e.g., machine-learned rules). In one specific example, the rules (e.g., machine-learned rules) can be overridden (e.g., overridden in real-time). In one specific example, the machine-learning can learn one or more user preferences. In one specific example, the system can learn from known pictures and/or during interactions. For instance, the system “hears” someone say “Hello, John”—the system can thus learn John's face. In one specific example, the system can accept verbal commands.

As described herein, various embodiments can provide a mechanism to block holographic presentation of a child. A child can be recognized, for example, by image analysis of body size (e.g., small body) and/or movement (e.g., a child can be identified as such due to high frequency and sudden movements).

As described herein, various embodiments can provide a mechanism to identify a given person via image analysis of face (e.g., facial features) and/or via image analysis of other body feature(s). In one specific example, privacy can be maintained by utilizing a hash function with respect to facial/body features. In one specific example, a holographic projector can be instructed (e.g., by the system) to block image(s) associated with a particular hash function and/or a particular hash function result (this can help avoid, for example, a man-in-the-middle attack). In another specific example, a person can be asked (e.g., by the system) to move to certain angles in order to facilitate identification.

As described herein, various embodiments can provide a mechanism to facilitate holographic communication with a desired delay (e.g., 5 second delay between sending side and receiving side).

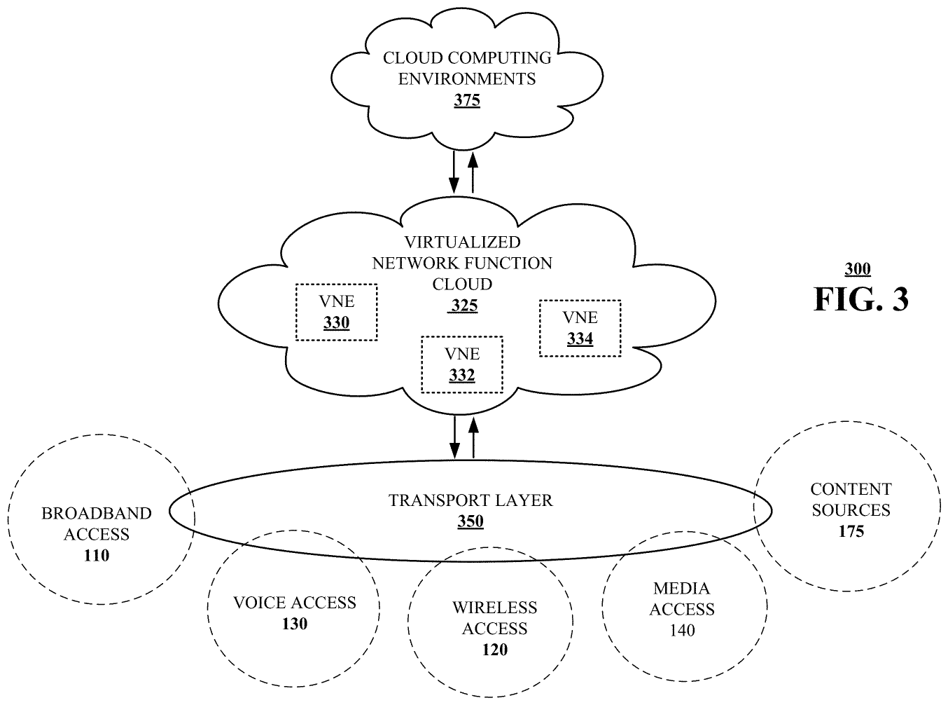

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the subsystems and functions of system 2000, some or all of the subsystems and functions of system 2100, some or all of the functions of method 2200, some or all of the functions of method 2300, and/or some or all of the functions of method 2400. For example, virtualized communication network 300 can facilitate in whole or in part call blocking and/or prioritization in holographic communications.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

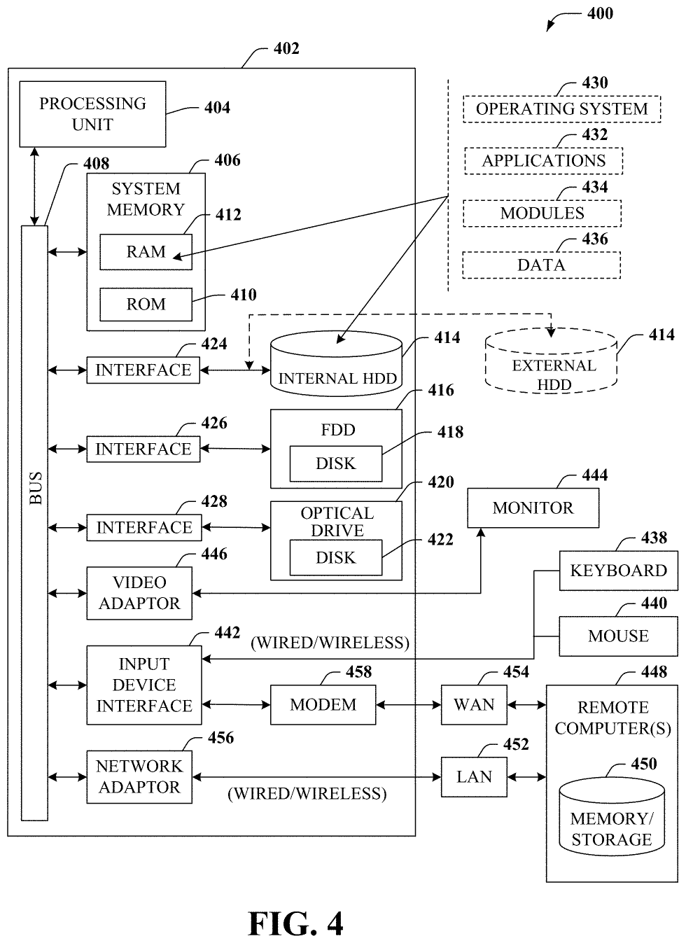

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part call blocking and/or prioritization in holographic communications.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

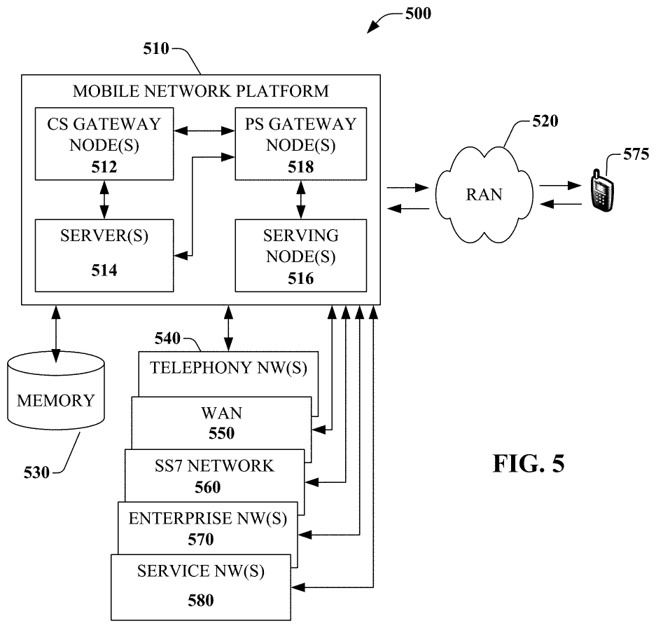

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part call blocking and/or prioritization in holographic communications. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

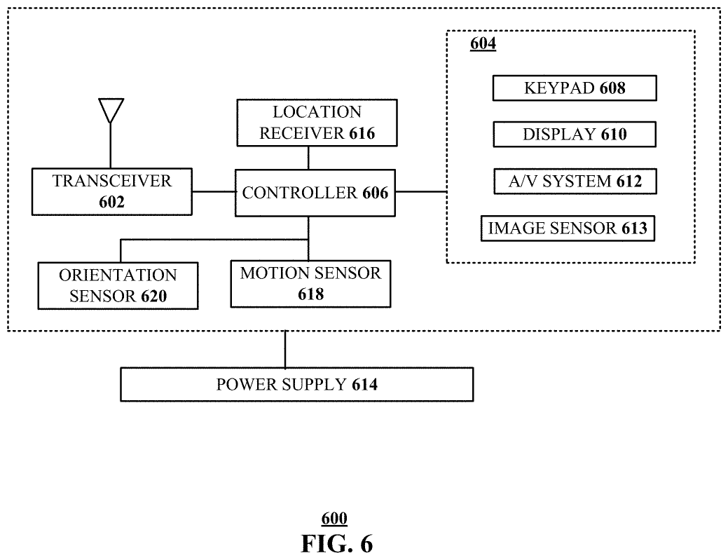

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part call blocking and/or prioritization in holographic communications.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically implementing call blocking and/or prioritization in holographic communications) can employ various AI-based schemes for carrying out various embodiments thereof. Moreover, the classifier can be employed to determine a ranking or priority of each call. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the calls and/or users have higher priority, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
receiving first imaging data corresponding to first images of a first plurality of first users, each of the first users being located at a first location;
obtaining first hierarchical rank data, the first hierarchical rank data being indicative of a first hierarchical ranking of each of the first users relative to each other of the first users;
generating, based at least in part upon the first imaging data and the first hierarchical rank data, second imaging data, and
sending the second imaging data to a second location, the second location being separate from the first location, the second imaging data enabling a first holographic projector at the second location to present first holograms, the first holograms comprising one or more first emphasized images representing a first particular one of the first users who is ranked highest by the first hierarchical rank data, and the first holograms further comprising one or more first un-emphasized images representing one or more first other users of the first users who are not ranked highest by the first hierarchical rank data.

2. The device of claim 1, wherein the first imaging data comprises video data.

3. The device of claim 2, wherein the first imaging data is obtained from one or more video cameras at the first location.

4. The device of claim 1, wherein the first hierarchical rank data is obtained from one or more user profiles, from one or more hierarchical rank databases, or from any combination thereof.

5. The device of claim 1, wherein each of the first users is a worker at a business entity.

6. The device of claim 5, wherein the first hierarchical ranking of each of the first users relative to each other of the first users is based upon an organization chart for the business entity, a seniority of each of the first users, or any combination thereof.

7. The device of claim 1, wherein the second imaging data comprises video data, metadata, or any combination thereof.

8. The device of claim 1, wherein the metadata is indicative of the first hierarchical ranking of each of the first users relative to each other of the first users and wherein the metadata is used by the first holographic projector to project each of the one or more first emphasized images and each of the one or more first un-emphasized images.

9. The device of claim 1, wherein the sending the second imaging data to the second location comprises transmitting the second imaging data via a wireless network, via a wired network, via the Internet, or by any combination thereof.

10. The device of claim 1, wherein the one or more first emphasized images comprises a visible outline that at least partially surrounds a representation of the first particular one of the first users.

11. The device of claim 1, wherein the one or more first un-emphasized images comprises a burred representation of the one or more first other users.

12. The device of claim 1, wherein the operations further comprise:
receiving third imaging data corresponding to second images of a second plurality of second users, each of the second users being located at the second location;
obtaining second hierarchical rank data, the second hierarchical rank data being indicative of a second hierarchical ranking of each of the second users relative to each other of the second users;
generating, based at least in part upon the third imaging data and the second hierarchical rank data, fourth imaging data, and
sending the fourth imaging data to the first location, the fourth imaging data enabling a second holographic projector at the first location to present second holograms, the second holograms comprising one or more second emphasized images representing a second particular one of the second users who is ranked highest by the second hierarchical rank data, and the second holograms further comprising one or more second un-emphasized images representing one or more second other users of the second users who are not ranked highest by the second hierarchical rank data.

13. A non-transitory machine-readable medium comprising executable instructions that, when executed by a processing system including a processor, facilitate performance of operations, the operations comprising:
obtaining, from one or more first video cameras located at a first location, first imaging data, the first imaging data corresponding to first images of a first plurality of first users, each of the first users being located at the first location;
obtaining first hierarchical rank data, the first hierarchical rank data being indicative of a first hierarchical ranking of each of the first users relative to each other of the first users;
generating, based at least in part upon the first imaging data and the first hierarchical rank data, second imaging data, and
transmitting the second imaging data to a second location that is separate from the first location, the second imaging data facilitating a first presentation by a first holographic projector at the second location, the first presentation comprising first holographic images, the first holographic images comprising a first substantially central holographic image representing a first particular one of the first users who is ranked highest by the first hierarchical rank data, and the first holographic images further comprising one or more first flanking holographic images representing one or more first other users of the first users who are not ranked highest by the first hierarchical rank data.

14. The non-transitory machine-readable medium of claim 13, wherein:
the first plurality of first users comprises a first user, a second user, and a third user;
the first user is the first particular one of the first users who is ranked highest by the first hierarchical rank data; and
the first substantially central holographic image representing the first user is presented in the first presentation between a first flanking holographic image representing the second user and a second flanking holographic image representing the third user.

15. The non-transitory machine-readable medium of claim 14, wherein the first substantially central holographic image representing the first user is presented in the first presentation horizontally between the first flanking holographic image representing the second user and the second flanking holographic image representing the third user, with the first flanking holographic image being on a right side of the first substantially central holographic image, and with the second flanking holographic image being on a left side of the first substantially central holographic image.

16. The non-transitory machine-readable medium of claim 13, wherein:
the first plurality of first users comprises a first user, a second user, a third user, and a fourth user;
the first user is the first particular one of the first users who is ranked highest by the first hierarchical rank data; and
the first substantially central holographic image representing the first user is presented in the first presentation in a substantially central location, with each respective flanking holographic image representing the second user, the third user, and the fourth user being around the first substantially central holographic image.

17. The non-transitory machine-readable medium of claim 13, wherein the operations further comprise:
obtaining, from one or more second video cameras located at the second location, third imaging data, the third imaging data corresponding to second images of a second plurality of second users, each of the second users being located at the second location;
obtaining second hierarchical rank data, the second hierarchical rank data being indicative of a second hierarchical ranking of each of the second users relative to each other of the second users;
generating, based at least in part upon the third imaging data and the second hierarchical rank data, fourth imaging data, and
transmitting the fourth imaging data to the first location, the fourth imaging data facilitating a second presentation by a second holographic projector at the first location, the second presentation comprising second holographic images, the second holographic images comprising a second substantially central holographic image representing a second particular one of the second users who is ranked highest by the second hierarchical rank data, and the second holographic images further comprising one or more second flanking holographic images representing one or more second other users of the second users who are not ranked highest by the second hierarchical rank data.

18. A method comprising:
receiving, by a processing system including a processor, first imaging data, the first imaging data corresponding to a plurality of first people who are located at a first location;
obtaining, by the processing system, first hierarchical rank data, the first hierarchical rank data being indicative of a lowest-ranked person from among all of the first people;
generating, by the processing system, based at least in part upon the first imaging data and the first hierarchical rank data, second imaging data, and
transmitting, by the processing system, the second imaging data, the second imaging data being transmitted to a second location that is separate from the first location, the second imaging data enabling a first holographic projector at the second location to present first holographic images, the first holographic images comprising one or more first de-emphasized images representing the lowest-ranked person.

19. The method of claim 18, wherein:
the first imaging data comprises first video data;
the first imaging data is obtained from one or more video cameras at the first location;
the second imaging data comprises second video data and metadata;
the metadata is indicative of the first hierarchical ranking;
the metadata is used by the first holographic projector to project the one or more first de-emphasized images representing the lowest-ranked person;
the one or more first de-emphasized images comprise a burred representation of the lowest-ranked person; and
the first holographic images further comprise one or more first non-de-emphasized images representing one or more other people of the first people who are not ranked lowest by the first hierarchical rank data.

20. The method of claim 18, further comprising:
receiving, by the processing system, third imaging data, the third imaging data corresponding to a plurality of second people who are located at the second location;
obtaining, by the processing system, second hierarchical rank data, the second hierarchical rank data being indicative of another lowest-ranked person from among all of the second people;
generating, by the processing system, based at least in part upon the third imaging data and the second hierarchical rank data, fourth imaging data, and
transmitting, by the processing system, the fourth imaging data, the fourth imaging data being transmitted to the first location, the fourth imaging data enabling a second holographic projector at the first location to present second holographic images, the second holographic images comprising one or more second de-emphasized images representing the lowest-ranked person from among all of the second people.
